(19) United States
(12) Patent Application Publication
(10) Pub. No.: US 2017/0050455 A1
(43) Pub. Date: Feb. 23, 2017

(54) REUSING PRINTING PAPER

(71) Applicant: Pradyot Midya, Palatine, IL (US)

(72) Inventor: Pradyot Midya, Palatine, IL (US)

(21) Appl. No.: 15/340,912

(22) Filed: Nov. 1, 2016

(51) Int. Cl. B41J 29/393; B41J 13/00

(52) U.S. Cl. CPC B41J 29/393; B41J 13/0009

(57) ABSTRACT

A printer includes a scanner to scan the previously printed paper. Software creates a file of areas that need to be blanked out around the areas already printed. A blanking mechanism covers areas that need to be blanked out with white ink or white toner the on previously printed paper. A print mechanism prints a new file over the blanked out paper.

### BACKGROUND OF THE INVENTIONS

1. Technical Field

The present inventions relate to printers and, more particularly, relate to a reuse of printed paper for printing.

2. Description of the Related Art

The printers in the market reduce paper usage by printing on both sides of the paper. However, they use a piece of paper only once. The printed paper may then be recycled where significant energy is spent in decomposing the paper back to pulp, bleached and then reformed to rolls, then cut and sized. In most cases the final size and shape of the paper is the same as it started out as. An enormous amount of energy is wasted and there is significant cost associated with this process. In fact, the commercial value of printed paper that is going to be recycled is near zero. Further, printed paper that has to be shredded has negative commercial value and document shredding companies have to be paid to process them.

### BRIEF DESCRIPTION OF THE DRAWINGS

The present inventions relate to reusing printing paper by making paper reprintable. The inventions do so in the following manner: The inventions scan paper to determine what parts of the paper have ink on it or it examines the source file of the printed page to determine what parts of the paper have ink on it. Then the printer uses an algorithm to determine what parts of the paper the printer will apply white ink onto, using information from the first step.

The invention aims to reuse printed paper by printing an opaque white pigment or toner over the portion of the paper that has ink on it to make the paper blank. This blank paper can then be printed upon. Since the thickness of the toner is much less than the thickness of the paper it can be reused multiple times. This would conserve paper, energy and reduce cost of paper. One option is to process paper that has already been printed on by printing a coat of white ink or toner on the entire sheet of the previously printed on paper, thus making it completely blank. This process will make the previously printed on paper reprint able. However, toner cost is also a significant portion of printing cost and it is desired to minimize toner quantity and its cost. It is only necessary to put the opaque white ink or toner where it was already printed.

The thickness of the paper is more than an order of magnitude more than the thickness of the layer of ink. Thus reusing a sheet of printed paper to print a new document would work except that the previously printed areas would create a combined image of the desired document and the previous document. For example, standard printing paper is about 0.5 mm thick. About 0.05 gram of toner is deposited on a standard 8.5 inch by 11.5 inch sheet of paper. Assuming that a written page of paper is covered 5% with ink the area of the paper covered by the ink is about 25 cm squared. Assuming the density of the toner is 1 gram/cubic centimeter the volume of 0.05 gram of toner is 0.05 cubic centimeter. The thickness of dried toner is about 0.002 cm or 0.02 mm. Thus the thickness of the toner on the paper is much smaller than the thickness of the paper. Thus multiple uses of the paper will not thicken it appreciably. After a large number of uses the paper will thicken significantly as well as get physically frayed. At this point the paper is suitable for recycling. Being able to reuse a paper just twice would effectively halve the cost of paper. Reusing a sheet of paper ten times would reduce the cost of paper by a factor of ten. There are significant environmental benefits well beyond just the cost of paper saved. An example of opaque white toner is Titanium dioxide. There are many other choices as well. It is desirable the material used needs to be white, opaque, nontoxic and inexpensive.

The present invention is illustrated by way of example and is not limited by the accompanying figures, in which like references indicate similar elements. Elements in the figures are illustrated for simplicity and clarity and have not necessarily been drawn to scale.

The details of the preferred embodiments will be more readily understood from the following detailed description when read in conjunction with the accompanying drawings wherein:

FIG. 1 illustrates a diagram of the system where an inkjet or laser printer is used to produce a blanked paper which coated with white-ink according to embodiments of the present inventions;

FIG. 2 illustrates a diagram of the system with text on white paper and after the blanking using white ink or toner according to embodiments of the present inventions;

FIG. 3 illustrates a diagram showing a radius of tolerance around a single letter of text to produce the blanking area where the white toner or ink will be used according to embodiments of the present inventions;

FIG. 4 illustrates a diagram of the printer starting with a previously printed page which is first blanked and made suitable for being printed upon according to embodiments of the present inventions;

FIG. 5 illustrates a diagram of the printer starting with a previously printed page which has been blanked is printed upon according to embodiments of the present inventions; and

FIG. 6 illustrates a flowchart according to embodiments of the present inventions.

### DETAILED DESCRIPTION OF THE PREFERRED EMBODIMENTS

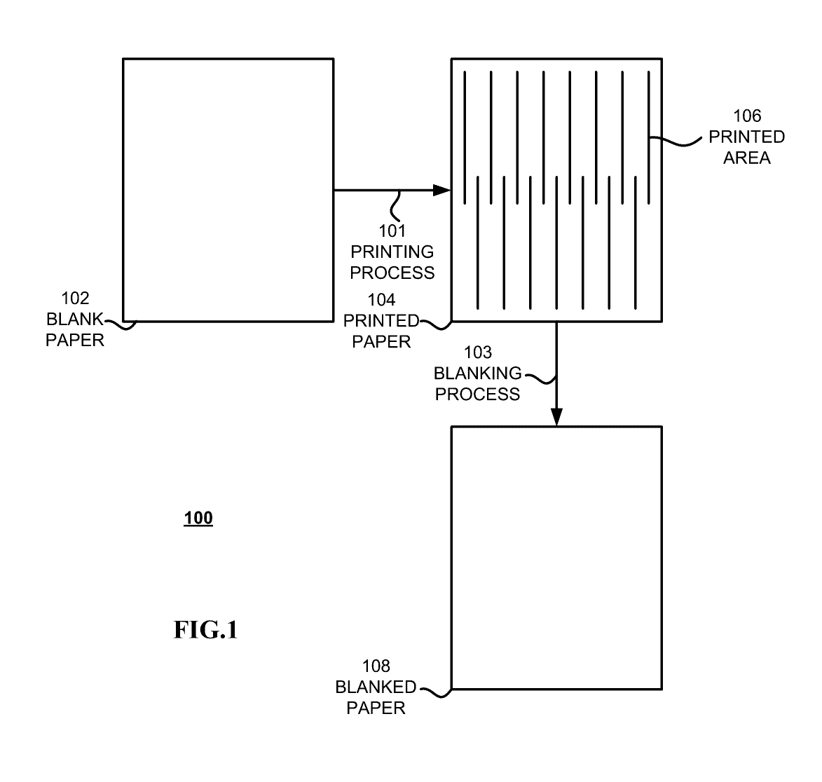

FIG. 1 illustrates a diagram of the system where an inkjet or laser printer is used to produce a blanked paper which coated with white-ink according to embodiments of the present inventions. In FIG. 1 the blank paper 102 is going to the printer and produces printed paper 104. The printer using the blanking process 103 prints white ink over the printed areas 106 of the paper that already have ink on it, to produce blanked paper 108 and which is now reprintable.

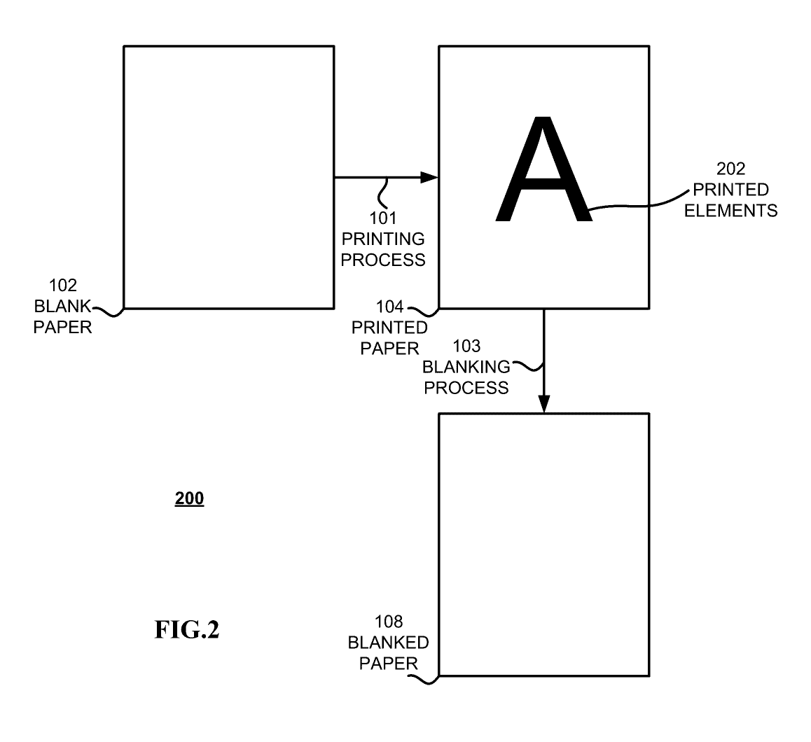

FIG. 2 illustrates a diagram of the system with text on white paper and after the blanking using white ink or toner according to embodiments of the present inventions. In FIG. 2 a printed element 202 on a printed paper 104 is blanked and made suitable for reprinting using the blanking process 103 which prints white ink or toner. Here the printer prints white ink over individual letters as to make those parts blank and make the paper reprintable, while minimizing the amount of white ink or toner used. If the entire page is coated with the white ink or toner the price of toner may easily exceed the price of the paper saved. This may be acceptable from an environmental standpoint but may not be financially viable. Minimizing the amount of white ink or toner used creates a solution that is financially and environmentally viable.

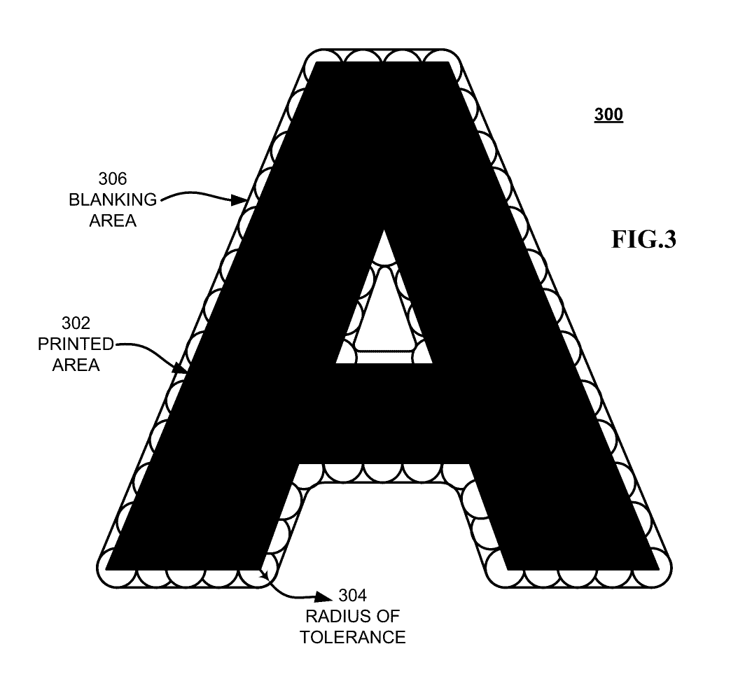

FIG. 3 illustrates a diagram showing a radius of tolerance around a single letter of text to produce the blanking area where the white toner or ink will be used according to embodiments of the present inventions. FIG. 3 is a close up diagram of the generation of the blanking area from the printed area. From the edges of the printed area 302 circles with radius of tolerance 304 are drawn. The blanking area 306 is created which includes the text and the neighborhood area of text. This system is used to identify what parts of the paper need to be printed over with white ink or toner. The figure illustrates an upper case letter A being analyzed by software. Thus the entire letter, plus some extra space around the letter determined by the radius of tolerance, is to be covered by white ink. The radius of tolerance may be programmable dependent on the resolution of the printer and quality of the paper used as well as the final quality requirements.

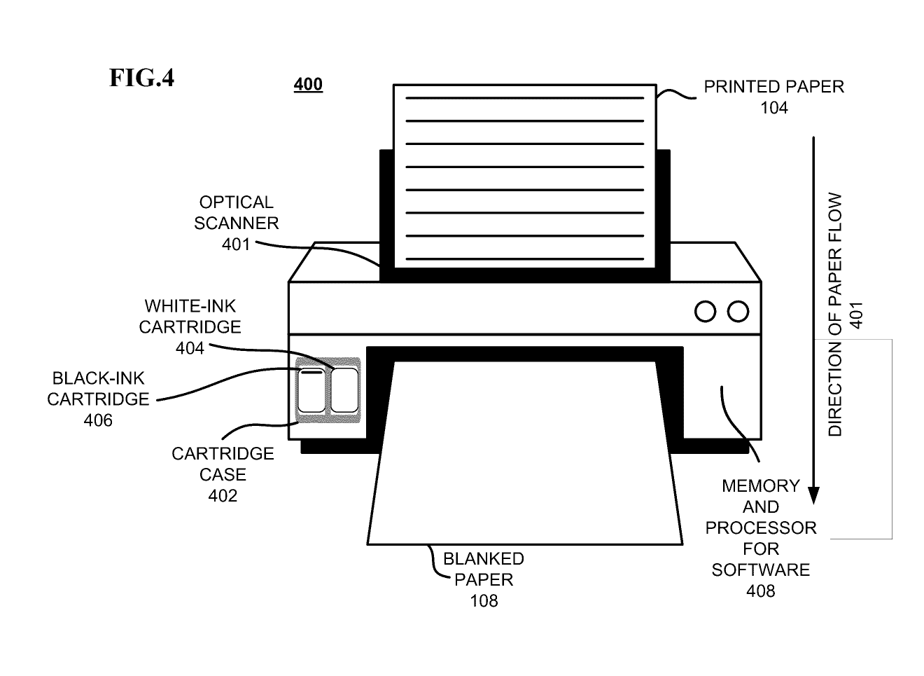

FIG. 4 illustrates a diagram of the printer implementing the invention. In FIG. 4 the printer starts with a previously printed page which is first blanked and made suitable for being printed upon according to embodiments of the present inventions. The printer takes printed paper 104 as an input and produces blanked paper 108 as an output. The direction of paper flow 401 is shown. This embodiment uses liquid ink which is stored in a cartridge. This is for a printer that prints in black and blanks in white. The cartridge case 402 holds the white-ink cartridge 404 and the black cartridge 406. Conventional color printers print multiple colors like cyan, magenta, yellow and black in a single pass. Color printer embodiments would have multiple colors like cyan, magenta, yellow and black inks. Other embodiments may use solid powder toner. In such embodiments there would be multiple toner cartridges with dry toner colors like cyan, magenta, yellow and black. For the purpose of blanking it may be necessary to scan the paper.

An optical scanner 401 is part of the input feed to the printer 400. The optical scanner 401 identifies print on the printed paper 104. This identified print is saved in memory using a processor and software 408. The printer function of the printer 400 them uses the white-ink cartridge 404 or white toner to apply white over black regions of print identified by the optical scanner 401. Thus using a built in scanner and the software we end up with a machine that seamlessly uses previously printed paper. In the case of non-white paper, a color other than white might be used to perform such erasure. This invention can be also be implemented such that the blanking and then printing the new file can be done in a single pass.

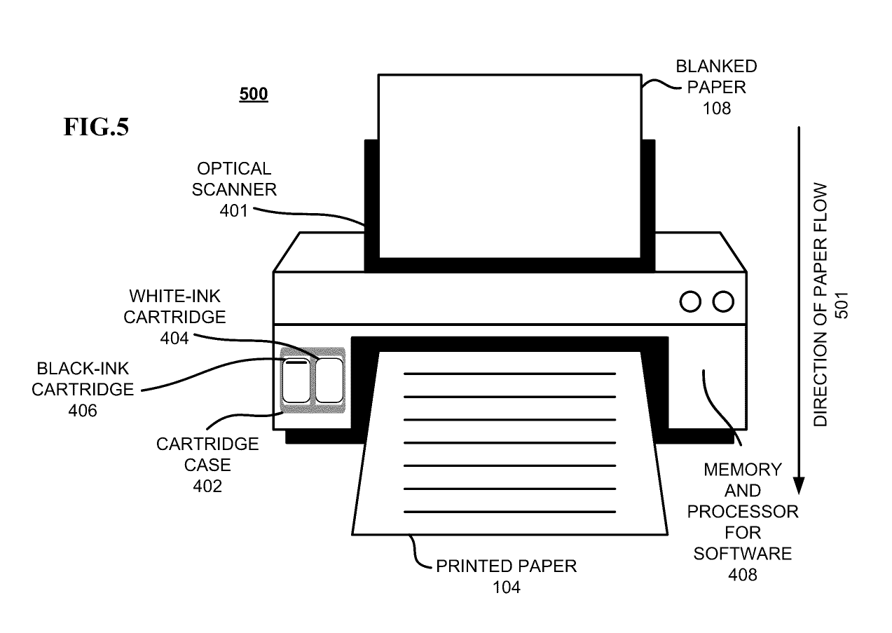

FIG. 5 illustrates a diagram of the printer starting with a previously printed page which has been blanked is printed upon according to an embodiments of the present inventions. An optical scanner 501 can be part of the input feed to the printer 500 as in FIG. 4. Print identified by the scanner 501 can be saved in memory using a processor and software 408.

The printer 500 takes the blanked paper 108 as input and produces printed paper 104 output. The direction of paper flow 501 is shown. This embodiment uses liquid ink which is stored in a cartridge. This is for a printer that prints in black and blanks in white. The cartridge case 402 holds the white-ink cartridge 404 and the black cartridge 406. Conventional color printers print multiple colors like cyan, magenta, yellow and black in a single pass. Color printer embodiments would have multiple colors like cyan, magenta, yellow and black inks. Other embodiments may use solid powder toner. In such embodiments there would be multiple toner cartridges with dry toner colors like cyan, magenta, yellow and black. For the purpose of blanking it may be necessary to scan the paper. Scanners are part of conventional printers. Thus using the built in scanner and the software we end up with a machine that seamlessly uses previously printed paper. This invention can be also be implemented such that the blanking and then printing the new file can be done in a single pass.

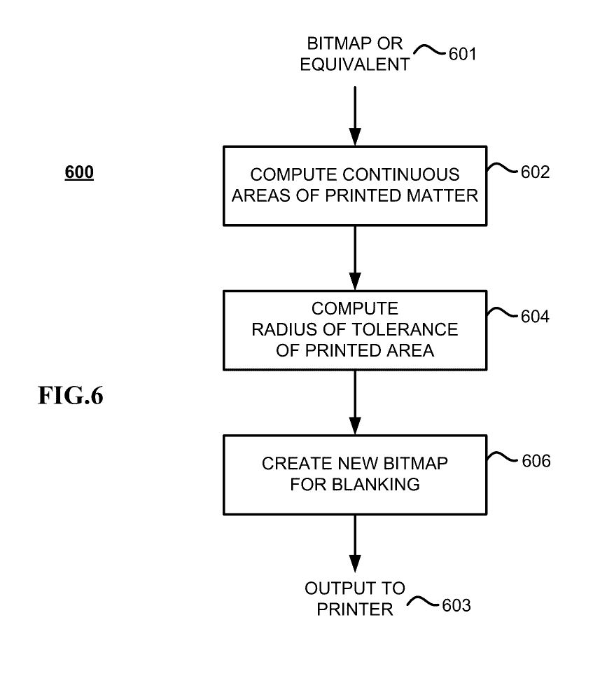

FIG. 6 illustrates a flowchart 600 according to embodiments of the present inventions to create the file to print the blanking area. Step 602 is used to identify the continuous parts of the paper need to be coated with white ink. Step 604 computes a radius of tolerance around the areas of printed area. Step 606 creates a new bitmap that includes the radius of tolerance for blanking. The final step 603 outputs to the printer a new bitmap for blanking the previously printed paper.

Unless stated otherwise, terms such as “first” and “second” are used to arbitrarily distinguish between the elements such terms describe. Thus, these terms are not necessarily intended to indicate temporal or other prioritization of such elements.

Any trademarks listed herein are the property of their respective owners, and reference herein to such trademarks is generally intended to indicate the source of a particular product or service.

Although the inventions have been described and illustrated in the above description and drawings, it is understood that this description is by example only, and that numerous changes and modifications can be made by those skilled in the art without departing from the true spirit and scope of the inventions. Although the examples in the drawings depict only example constructions and embodiments, alternate embodiments are available given the teachings of the present patent disclosure.

What is claimed is:

1. A printer comprising:
a scanner to scan the previously printed paper and identify print areas;
a memory and associated software operatively coupled to the scanner to save identified print areas that need to be blanked out around the areas already printed; and
a blanking mechanism operatively coupled to the memory to cover with white ink or white toner the identified print areas that need to be blanked out to output blanked out paper.

2. A printer according to claim 1, further comprising a print mechanism to print a new file over the blanked out paper.

3. A printer according to claim 1, wherein the software identifies a recently printed file and page using the scan result.

4. A printer according to claim 1, wherein the software uses a radius of tolerance around all the printed areas.

5. A method of reusing printed paper comprising of
(a) scanning previously printed paper to identify previously printed portions;
(b) blanking the previously printed paper by printing white toner or white ink over the previously printed portions of the paper to output blanked paper; and
(c) printing a new document over the blanked paper.

6. A method according to claim 5 further comprising the step of (d) identifying a recently printed file and page from the scan.
